(19) United States
(12) Patent Application Publication
(10) Pub. No.: US 2011/0246389 A1
(43) Pub. Date: Oct. 6, 2011

(54) Electronic trading spooler

(76) Inventors: Marcin Szymon Ziolek, Oberarth (CH); Stephen Mark Adams, London (GB); James B. Litsios, Gockhausen (CH); Lars Hjaltman, Prestbury (GB)

(21) Appl. No.: 12/798,130

(22) Filed: Mar. 30, 2010

(51) Int. Cl. G06Q 40/00; G06F 9/46; G06F 9/50

(52) U.S. Cl. 705/36 R; 705/37; 718/103; 718/104

(57) ABSTRACT

A spooler for a computerized trading system is provided. The spooler acts as a master to a calculation engine slave that calculates the desired state of the orders and quotes in the market. Thus, the spooler controls the high-level allocation of computational and communicational resources of the computerized trading system and the calculation engine receives from the spooler what to calculate. The spooler imposes when necessary an overall priority of calculation of the trading system that supports the spooling activity. The spooler comprises a scheduler and a package assembly. The scheduler determines the current state of the underlying prices relative to the underlying prices used to calculate quotes still active in the exchange and whether the computational resources of the trading system should focus as much as possible on preparing quoting operations, or whether other activities of the trading system can be done. The package assembly prepares quoting operations and builds the quoting operation data package. Depending on the state of the system, the scheduler operates in different modes: a “normal computations” mode, a “priority computations” mode, and a “masshold” mode.

### FIELD OF THE INVENTION

The present invention relates to computerized trading systems.

### BACKGROUND OF THE INVENTION

At one time, there were only open-outcry exchanges where brokers and traders, or more specifically buyers and sellers, would come together to trade in person. More recently, electronic exchanges that process automatic and electronic matching of bids and offers have been introduced. Thus, trading methods have evolved from a manually intensive process to a technology enabled, electronic platform.

Many exchanges throughout the world implement electronic trading in varying degrees to match buyers and sellers of tradeable objects, where a tradeable object refers simply to anything that can be traded. Tradeable objects may include, but are not limited to, all types of traded financial products, such as, for example, stocks, options, bonds, futures, currency, and warrants, as well as funds, derivatives, and collections of the foregoing, and all types of commodities, such as grains, energy related products, and metals.

Electronic trading has made it easier for people in diverse geographic locations to more efficiently participate in the financial markets. With the advent of electronic trading, a trader can be in direct contact simultaneously with multiple markets, from practically anywhere in the world, performing near real-time transactions, all without the need to make personal contact with a broker for a trade. The lack of manual intervention required to trade has led to a sharp decline in transactions costs, both in the form of exchange and processing fees as well as brokerage fees. Declining costs, more efficient executions, as well as macroeconomic trends, have resulted in a general increase in trading activity while more and more derivative contracts have migrated from traditional floor execution to various electronic platforms. The increase in the number of market participants and lower transaction costs has generally led to more competitive markets and greater liquidity.

In a traditional pre-electronic options trading floor setting, the floor traders are generally willing to make markets in many different financial instruments. This is particularly important in the case of options markets where a wide variety of financial instruments might trade on any given day (or moment). Trying to mimic a similar arrangement on an electronic trading platform presents a series of challenges. In many markets a large number of outright options result in a virtually infinite number of possible combinations of these options. In addition, if a market maker is to provide liquidity in many of these options and their combinations in the form of posting continuously updating electronic markets, that market maker is potentially exposing himself to a large amount of risk in the event of a technology slow down or an abrupt change in market sentiment.

Electronic trading is generally based on centralized (host) computers, one or more computer networks, and exchange participant's (client) computers. In general, the host exchange includes one or more centralized computers. The operations of the host exchange typically include order matching, maintaining order books and positions, price information, and managing and updating the database for the online trading day as well as nightly batch runs. The host exchange also is equipped with external interfaces that maintain contact to quote vendors and other price information systems. Some exchanges allow colocation (or co-location) which makes available computers or physical locations for the client's computer in close proximity to the exchange computers.

Using client devices, market participants or traders link to the host exchange through one or more computer networks. A computer network is a group of two or more computers or devices linked together. There are many types of wired and wireless networks such as local area networks and wide area networks. Networks can also be characterized by topology, protocol, and architecture. For example, some market participants may link to the host through a direct connection such as a T1 or ISDN. Some participants may link to the host exchange through direct connections and through other common network components such as high-speed servers, routers, and gateways. The Internet can be used to establish a connection between the client device and the host exchange. There are many different types of networks and combinations of network types that can link traders to the host exchange.

Regardless of what interface a trader uses to enter orders and quotes in the market, each market supplies and requires a common set of information to and from every trader. The bids and offers in the market make up the market data and everyone logged on to trade can receive this information if the exchange provides it. Similarly, every exchange requires that certain information be included in each order. For example, traders must supply information like which asset is to be traded, the quantity, any restrictions, price, whether it is a buy or a sell order, and multiple other variables. Without all of this information, the exchange will not accept the order. Thus, a significant amount of data is electronically exchanged between the exchanges and the traders.

Software running on client devices allows market participants to log onto one or more exchanges and participate in the market. A client device is a computer such as a personal computer, laptop computer, hand-held computer, and so forth that has network access. Client devices often run software that creates specialized interactive trading screens. The trading screens enable traders to enter and execute orders, obtain market quotes, and monitor positions. Client devices will also often run trade automation software that will automatically perform trading operations based on different inputs such as market prices. Trade automation is often referred to as algorithmic trading. The range and quality of features available to traders on their screens and automation varies according to the specific software application being run. The installation of open interfaces in the development of an exchange's electronic strategy means users can choose, depending on their trading style and internal requirements, the means by which they will access the exchange.

To effectuate an electronic order, a buy order or a sell order is sent by a client device to the host exchange. Upon receipt of the order, the host exchange determines if a match exists. More specifically, the host exchange checks the conditions associated with the order, for example order price and quantity, and compares the conditions associated with the order with orders resting in the host exchange electronic order book. If a match does not exist, the host exchange prioritizes the order with other orders (if any) in the electronic order book of the same price. (Some electronic markets prioritize orders first in the electronic order book and then attempt to match them). Priority may be dependent on the individual specification of the market. Generally, a match exists when the order conditions are satisfied in the market. If a match exists, then a fill confirmation message is commonly sent to the client device. In addition, all subscribing traders, including those involved in the trade, get some or all of the updated electronic order book information by way of new market information. If the match does not exist, depending on the type of order, the order will disappear or stay active in the exchange awaiting further possible matches. An order that stays active in the exchange is called a resting order and may later be updated (with new price and/or quantity)

Resting orders need to be updated to reflect changes to the value of the tradable objects to which they refer. If this process of updating orders is not done sufficiently quickly, the trader may lose money. For example, the trader may be buying something at a higher value than the actual price. This could happen because his resting order is still reflecting a higher older value, while new information has circulated which devalues the referred to object.

A tradable financial object that references another financial object is often called a derivative product and has a value that often depends directly on the value of the financial object to which the derivative product refers. When this last value is liquid and readily available, but also possibly due to other reasons, the trader who leaves a resting order in the market is in competition with the trader who may wish to trade directly with that order (by entering a new order). An example of this is an equity option whose value depends on the value of a stock. A trader who enters a resting order on an equity option needs to update the price of his resting order in accordance to the value of the corresponding stock which is given by the price feed of that stock. As price feeds are available to others, the owner of the resting equity option order is often in competition with those that would trade with him after learning of a new stock price.

A resting order that gets overwritten as soon as another one is posted for a given instrument by the same trader is often referred to as a quote. Quotes can be seen as “light weight” resting orders as these generally allow only simple order behaviors. A pair of buy and sell quotes on the same tradable object that are managed together is often referred to as a double-sided quote. A pair of buy and sell quotes on the same tradable object that are managed in separation are often referred to as a single-sided quotes. Some traders specialize in maintaining quotes in the exchange (this is called quoting). Quoting is taking the risk of sometimes taking a loss because of not being able to update a trader's quotes fast enough, but this risk is often offset by the profit usually made on each buy or sell made. Quoting derivative products is often done with the assistance of automation that helps maintain quote updated in the exchange while the value of the quoted tradable object may change with each update of the prices of the financial objects, often called underlyings, referred to by the quoted derivatives.

Electronic exchanges often assist trading quotes by allowing some or all of their users to enter large numbers of quotes into the market in one operation. This can help to maintain large number of quotes simultaneously. And as a consequence, this helps increase the liquidity of the exchange. The messages that control multiple quotes are often referred as ‘multiple quote updates’.

The market is fluid as many traders are sending orders and quotes to the market simultaneously; in fact, successful markets strive to have a high volume of trading such that any trader who wishes to enter an order will find a match and have the order filled quickly. In such liquid markets, the prices of the security can fluctuate rapidly. The faster a trader can trade, the less likely it will be that the trader will miss his price and fail to execute a strategy. A skilled trader with the quickest software, the fastest communications, and the most sophisticated analytics can significantly improve the bottom line. The slightest speed advantage can generate significant returns in a fast moving market. In today's electronic markets, a trader lacking a technologically advanced interface is at a competitive disadvantage.

One potential slow down results from the multiplicity of traders and the volume of data being electronically exchanged on a given exchange. This volume is especially high with derivative exchanges where there is an immediate risk of loss if derivative resting orders or quotes are not updated upon learning of new underlying price moves. Because the exchanges are physically limited by the rate at which an exchange can process and match new orders and quotes or updates to existing orders and quotes, they normally artificially limit the amount of information that can be passed between an exchange and the traders. These restrictions are usually placed by the electronic exchanges on how much access any given trader has to the electronic exchange in a set amount of time. For example, the International Securities Exchange (ISE), 60 Broad Street, New York, N.Y. 10004 currently allows each market maker connection to perform eight operations per second. Examples of individual operations include: updating a single order, a group of 400 single-sided quotes or performing as mass hold. This means that once the allocation of operations for that second is used up the trader is unable to update again until the next second. In a fast moving market, this increases the latency of the updates and can result in significant risk.

A commonly used concept in derivative trading is the notion of theoretical price. A theoretical price of a tradable object is an inferred price based on current and historical observations. For example, a commonly used way to produce theoretical prices for certain derivatives is to use a numerical implementation of the Black/Scholes formula (Black, Fischer and Scholes, Myron, The Pricing of Options and Corporate Liabilities, Journal of Political Economy 81, 637-659 (1973)). Theoretical prices are useful in helping the market participants getting insights on the possible relations between the values of the different tradable objects.

Quoting derivative products that share the same underlying adds to the complexity that all quoted derivatives dependent on the same underlying price share the same need to have their quotes updated in the exchange to reflect a new underlying price. Care is normally taken to choose an order in which to update the quotes in the exchange so as to minimize the risk of financial loss. With the limit of the rate at which quote updates can be sent to the exchange, there is an effort not only to choose an optimal order but also to choose an optimal selection of which quotes to update first.

Competition in the speed at which updates can be provided to the exchanges leads to a possible system configuration where part of the physical computer and communication hardware is placed as close as possible to the exchange. In this context but also in other physical configurations, it is vital to optimally use the available computational resources of the hardware on which are run the tools that assist a market participant. Co-location is one way that the exchange can make it easier for clients to achieve close exchange proximity.

It is therefore desirable to offer tools that can assist a market participant in adapting his or her trading strategy to an electronic marketplace, help the participant to discover and execute desirable trades, post and manage a large number of quotes (two-sided markets), provide means for position, risk, and money management efficiently, as well as making the best use of the computational resources used in a cost effective manner. It is desirable to manage as finely as possible competing computation resources such as optimally sending orders and quotes to the exchange and performing other client trading operation such as, but not limited to, determining theoretical prices, portfolio and risk values, or trade automation. This need of efficient use of computational resource is also very relevant in collocation situations where the exchanges and cost impose physical limitations to the choice of the client's hardware.

### SUMMARY OF THE INVENTION

An electronic trading spooling system in accordance with the principles of the present invention assists market participants in adapting his or her trading strategy to an electronic marketplace, helps participants to discover and execute desirable trades, posts and manages a large number of two-sided markets, provides means for position, risk, and money management efficiently, as well as help make the best use of the computational resources of a trading system. An electronic trading spooling system in accordance with the principles of the present invention manages competing computation resources such as sending orders and quotes to the exchange and performing other client trading operation such as, but not limited to, determining theoretical prices, portfolio and risk values, or trade automation.

An electronic trading spooling system in accordance with the principles of the present invention acts as a master to a calculation engine slave that calculates the desired state of the orders and quotes in the market. Thus, the spooler controls the high-level allocation of computational and communicational resources of the computerized trading system. The spooler imposes when necessary an overall priority of calculation of the trading system that supports the spooling activity. The spooler provides scheduling and package assembly functionality.

The scheduler determines, with the current and expected upcoming throttling state of the quoting operations, the current state of the underlying prices relative current quotes active in the exchange, and with the expected time to prepare new quoting operations, whether the computational resources of the trading system should focus as much as possible on preparing quoting operations, or whether other activities of the trading system can be done.

The package assembly prepares quoting operations and builds the quoting operation data package. The scheduler incrementally maintains the expected amount of work to perform the package assembly for different underlying prices. Using this information, the scheduler triggers the package assembly while providing a list of orders or quotes that need updating.

Possible upcoming time and price combinations, over the upcoming time period and price ranges around current market prices, are divided into non-overlapping regions based on outstanding quote states, possible trading costs, and price valuation properties of the quoted products. The coverage of regions stops where there is too high a risk that the quoting operation may not be done quickly enough, or for possibly other reasons. The scheduler incrementally maintains the expected amount of work to perform the package assembly for different regions. Later price changes which when associated their time fall into specific regions may trigger order and quote computation, followed by package assembly. For the uncovered upcoming price changes that do not fall in a region the scheduler may trigger the package assembly to stop some or all of the quoting activity with the use of mass hold operations. When not driving quoting calculation or operations, the scheduler allocates computational resources to be freely used by the rest of the trading system. Depending on the state of the system, the scheduler operates in different modes: a “normal computations” mode, a “priority computations” mode, and the “masshold” mode.

### BRIEF DESCRIPTION OF THE DRAWINGS

FIG. 1 is a schematic of a non-limiting example hardware architecture that can be used to run the electronic trading spooling system of the present invention.

FIG. 2 is a process flow chart for an example list of eligible orders applied to a derivative market making strategy.

FIG. 3 is a simplified schematic graph of scheduler modes of the electronic trading spooling system of the present invention.

FIG. 4 shows the simplified schematic graph of scheduler modes of FIG. 3 with an additional underling price.

### DETAILED DESCRIPTION OF A PREFERRED EMBODIMENT

As previously described, one potential slow down results from the multiplicity of traders and the volume of data being electronically exchanged on a given exchange. Because of limits to the amount of information that can be processed by an exchange as well as the limits on what can be exchanged between an exchange and these traders, electronic exchanges place limits on quote update bandwidth. This is referred to as “throttling”, short for input/output throttling. While this technique can be used by the exchange to more efficiently handle its processing, throttling increases the time it takes to actually be served, such as when there are 100 users trying to be served 10 at a time.

Thus, electronic trading systems must spool their orders and quotes prior to communications with the electronic exchanges. Spooling, or simultaneous peripheral operations on-line, refers to the process of putting instructions or something that needs to be done into memory until the program or computer is ready to execute those instructions. In electronic trading, orders and quotes are put in a buffer, a special area in memory where a sending process can access the orders and quotes when it is ready. The buffer provides a waiting station where orders and quotes can rest while the sending process or the exchanges catches up.

In traditional quote spooling, a calculation engine calculates or recalculates the desired state of the quotes in the market in response to various external inputs, such as the underlying price and the derivative prices and various trader given parameterization. These prices are then pushed into a spooler component that is responsible for understanding the limitations of the order and quote update bandwidth and getting the orders and quotes into the market as fast as possible without violating the exchange provided bandwidth limitations.

Thus, traditional spooling employs a simple push system. The calculation engine is in control of the order it recalculates and thus the orders and quotes are pushed to the spooler. The spooler often contains sophisticated decision making systems to prioritize orders, quotes and packages thereof with respect to each other, but the spooler is still at the mercy of the system that is driving it and that system's calculation order and rates, as well as its potential high use of computation resources. In effect, the spooler acts as a slave to the calculation master.

In accordance with the principles of the present invention, the spooler in effect becomes the master to the calculation engine slave. A spooler of the present invention is made aware of the throttle and the underlying movements and the other parameterization. A spooler of the present invention can choose which calculations are important and the order in which those calculations can be done. This minimizes latency to the market, thus increasing both potential profit and reducing potential risk.

A spooler in accordance with the principles of the present invention performs optimal computation and communication resource allocation based on attributes. These attributes can include available throttle towards exchange, ladder of underlying values with corresponding order updating or quoting operations, and costs of their computation. Depending on the state of the system, a scheduler operates in different modes. Such modes can comprise a “normal computations” mode, a “priority computations” mode, and a “masshold” mode, as explained in detail below.

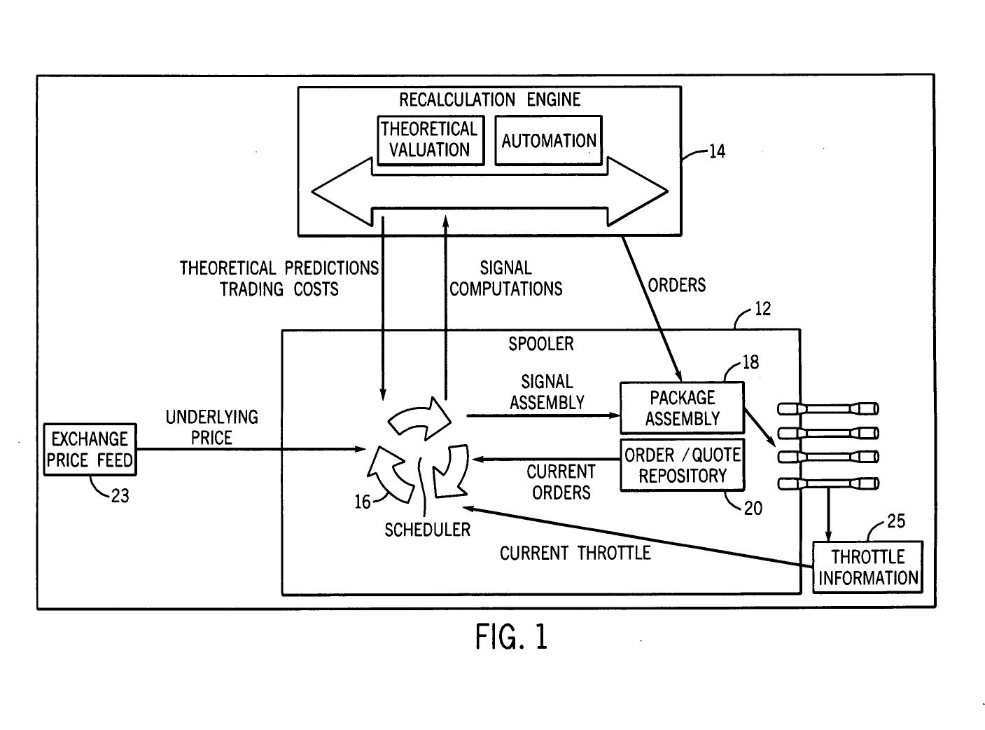

Referring now to the Figures, an exemplary spooler in accordance with the principles of the present invention is described in more detail. In FIG. 1, a schematic of a non-limiting example hardware architecture that can be used to run a spooler of the present invention is depicted. The architecture includes a spooler 12 and a calculation engine 14. The spooler 12 provides scheduling, package assembly, and repository functionality. For ease of reference, this functionality is non-limitingly depicted herein as a scheduler 16, a package assembly 18, and a repository 20. The spooler 12 receives from an exchange price feed pricing data 23 that can include an underlying price and derivative prices. The spooler 12 further receives from an exchange throttle information 25 which may include the profile of the throttle over time. Some exchanges further provide updates of the profile of the throttle directly indicating change of state of activity of the throttle while some exchanges provided general throttle information without indicating change of state of activity of the throttle. When an exchange provides updates of the profile of the throttle directly indicating change of state of activity of the throttle the spooler 12 can utilize this information to update the profile of the throttle. When an exchange provided general throttle information on the throttle without indicating change of state of activity of the throttle, spooler 12 utilize the general throttle information to update profile of the throttle.

The scheduler 16 makes resource allocation decision for both the computational as well as communicational resources of the overall trading system. This allocation is based on available throttle towards the exchange on one side and the prediction of orders and quotes that will need sending with their computational cost forecast on the other side. Predictions of orders that will need sending are organized into a ladder-like structure that is able to quickly produce a list of eligible orders and quotes for each incoming underlying or derivative price update. The prediction of the orders and quotes that need sending depends on the trading strategy adopted by the trader in the way the trader uses the calculation engine 14.

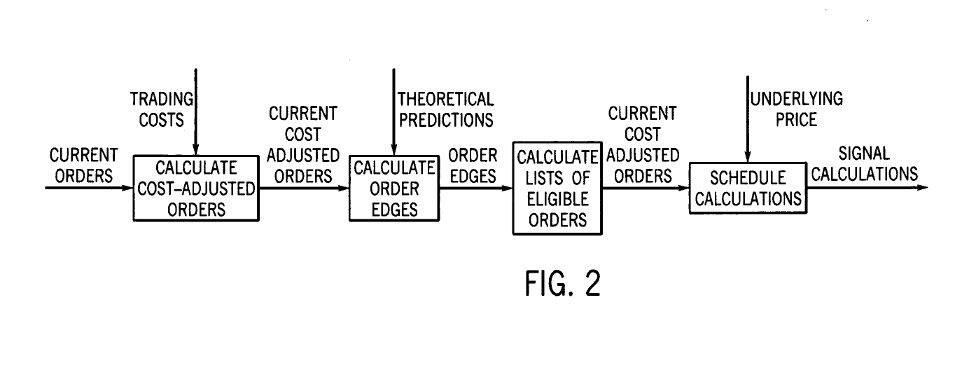

As a non-limiting example how the lists of eligible orders and quotes could be produced when the present invention is applied to a derivative market making strategy can be examined while referring to FIG. 2, which depicts a process flow chart. Current order and quote information and trading costs are input to calculate cost adjusted orders. Trading costs include, for example, exchange fees and possibly implied follow up cost to a trade. The current cost adjusted orders and theoretical predictions are input to calculate order edges. The order edge could indicate how much there is a risk of loss or a chance of profit. The order edges are utilized to calculate lists of eligible orders. The current cost adjusted orders and the underlying price are input to schedule calculations.

In this strategy, the trader is interested mostly in minimizing his exposure incurred by orders and quotes resting in the market as the underlying instrument moves. In that case, the scheduler input will comprise the predictions of the derivative theoretical prices for different underlying levels, the values of own orders and quotes currently published to the market, and the trading cost information. The prediction of the theoretical prices can be compared against the orders and quotes currently published to the market adjusted by the trading costs to discover at which underlying level the published orders and quotes turn into money-losing potential transactions. Then each underlying level can be accompanied with a list of money losing orders and quotes that need revisiting.

In a more general case, the prediction of eligible orders and quotes can depend on factors such as for example information about the predictions of the profit edge, the inferred benefit of being able to hedge or simply an arbitrary selection of orders made by the calculation engine. The scheduler then calculates and outputs signals to the calculation engine of what to calculate and signals to the package assembly to build packets.

The calculation engine is responsible for conducting the calculation of the exact values of the eligible orders and quotes. This process usually involves determining theoretical values of the derivatives involved, determining the current trading risk totals as well as processing detailed information about the prevailing trading conditions such as analyzing the top of the book and order depth on various exchanges. The calculation engine is customized to satisfy the specific need of the trader and final orders and quotes diverge from the initial predictions. These orders and quotes are then presented to the package assembly in form of intended actions to be taken in the market place.

The scheduler then provides a signal to the package assembly to trigger the creation of the data package. The package assembly then picks up the list of the orders and quotes produced by the calculation engine and augments it with the pre-existing list of hitherto unsent orders and quotes. The package assembly prioritizes the overall list and generates a data package of the size up to the maximum stipulated by a particular exchange. As a last step the data package is converted into a wire format dictated by a specific exchange application programming interface (API).

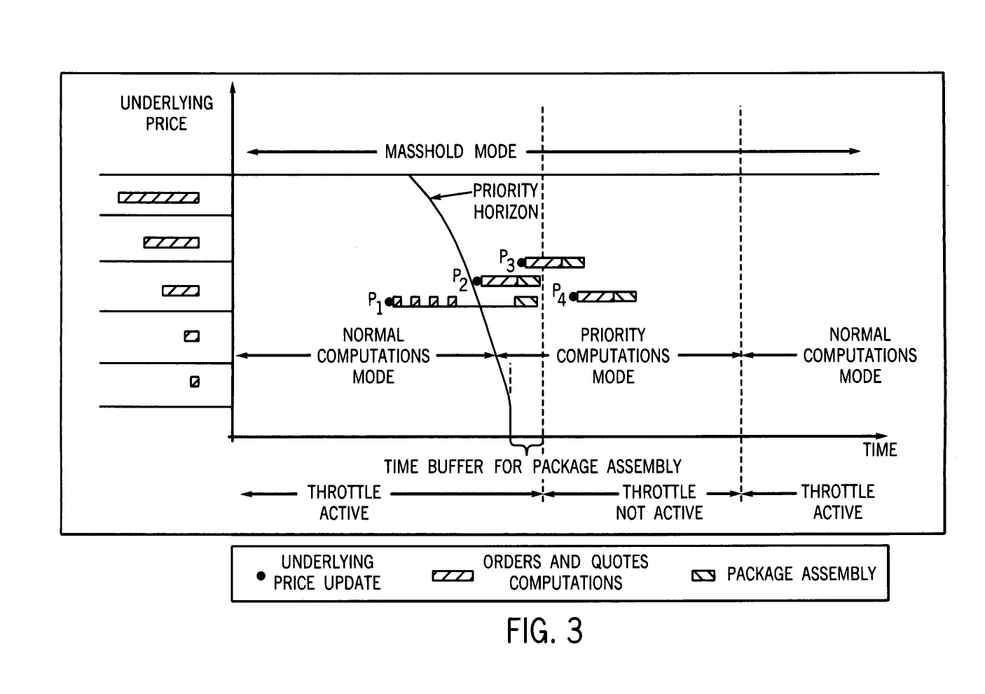

In accordance with the principles of the present invention, possible upcoming time and price combinations, over the upcoming time period and price ranges around current market prices, are divided into non-overlapping regions based on outstanding quote states, possible trading costs, and price valuation properties of the quoted products. Referring now to FIG. 3, a simplified schematic graph of scheduler operation is seen. In the graph, the vertical axis labeled “Underlying price” represents underlying price activity while the horizontal axis labeled “time” axis represents time. As seen on the horizontal axis, the time is divided into segments where the throttle blocks and allows operations to the exchange. Depending on the state of the system, the scheduler operates in different modes. As seen dependant on the underling price activity and location relative to priority horizon the scheduler can comprise the “masshold” mode, the “normal computations” mode, and the “priority computations” mode. One simplification of the graph in FIG. 3 is that it only schematizes the positive changes of the underlying; the graph could be symmetrically extended downwards to schematize the similar behaviors for negative underlying changes.

The “masshold” mode occurs when the underlying price activity is prohibitory high. Thus, if the underlying price change is high enough then a mass hold is triggered, such as for example sending a single, simple message setting quotes to zero to pull from the market. When the underlying price activity is below the “masshold” mode, the scheduler is in the “computations” mode. The “computations” mode comprises a “normal computations” mode and a “priority computations” mode.

Separating the “normal computations” mode and the “priority computations” mode is a “priority horizon”. As seen in FIG. 3, the base of the “priority horizon” is anchored on the time-line horizontal axis relative to the moment the throttle allows operations. At low underlying price activity priority horizon leaves a small time buffer required for package assembly, and dynamically extends backwards in time as the underlying price would imply increased activity along the vertical axis.

The “priority horizon” establishes when the scheduler goes from the “normal computations” mode to the “priority computations” mode. Thus, if the number of orders and quotes affected by an underlying price change is large enough that the scheduler will only complete a calculation at or after the moment throttle allows operations and the orders and quotes can be sent, then the scheduler will start the calculation immediately—the scheduler operates in “priority computations” mode. If number of orders and quotes affected by an underlying price change is sufficiently small that the scheduler can complete a calculation before throttle allows operations and the orders and quotes can be sent, then a higher priority update can be calculated first—the scheduler operates in “normal calculation” mode. If quotes affected by an underlying price change are made at the time when the throttle allows operations, then the course of action is the same as right after crossing the priority horizon boundary—the scheduler operates in the “priority computations” mode, only that the orders and quotes will not be finished immediately after the throttle allows operations but some time later than that.

In FIG. 3, each of the “bullet points” in the “computations” mode represents an underlying price update. Looking first to the update P₁ found closest to the origin of the graph, number of orders and quotes affected by an underlying price change is sufficiently small that the scheduler can complete a calculation before throttle allows operations and the orders and quotes can be sent; thus, the scheduler initiates a normal calculation. For the next closest update to the origin P₂, the number of orders and quotes affected by an underlying price change is large enough that the scheduler will only complete a calculation at or after the moment the throttle allows operations and the orders and quotes can be sent; thus, the scheduler initiates a priority calculation. Looking now to the updates found farthest from the origin of the graph, P₃ and P₄, an update was made while the throttle allows operations or briefly before; thus, the calculations will continue some time after the throttle allows operations. When a package is sent a new time to throttle allowing operations is calculated and the system begins the process again.

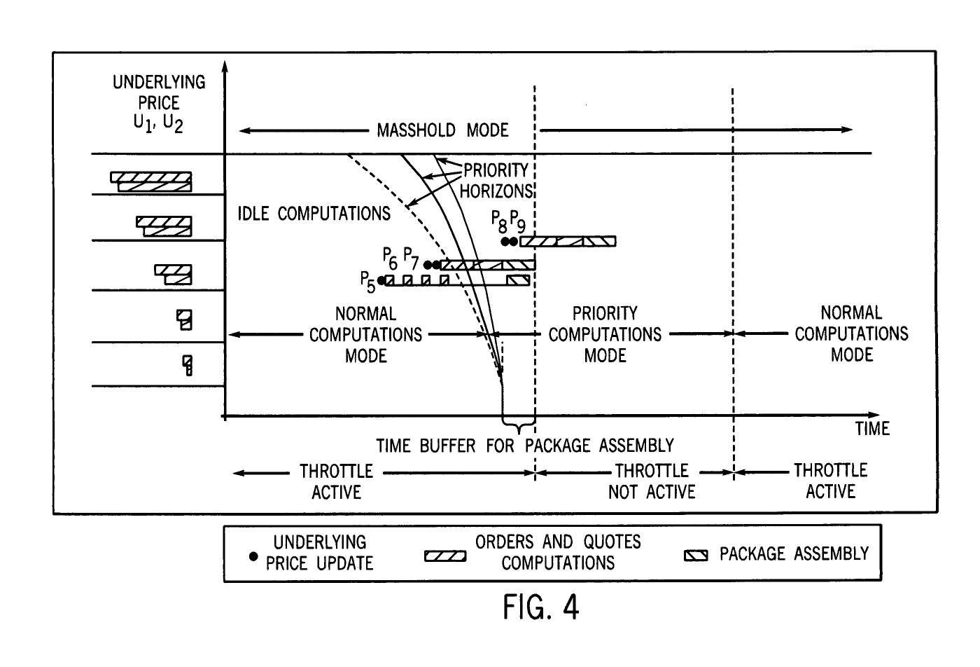

In the simplified schematic graph of scheduler modes of FIG. 3, the activity of only one underling price is shown. Of course, in a given exchange activity on a multiplicity of underling prices is occurring. If there are multiple quotes dependent on different underling prices then the scheduler computations needs to take account of which are the most urgent quotes given their underlying dependency and the total work that needs to be done before the throttle allows operations so that it can manage the calculations. Referring now to FIG. 4, the simplified schematic graph of scheduler modes of FIG. 3 is seen with an additional underling price.

In FIG. 4, the “priority horizon” for the single underlying price of FIG. 3 is seen as the darker line. A second priority horizon for the additional underling price is added, seen as the lighter line to the right or after in time of the priority horizon of FIG. 3. A third priority horizon is seen as a broken line to the left or before in time of the priority horizon of FIG. 3. This third priority horizon represents the priority horizon of the system based on the existence of two underlying prices.

Again, in FIG. 4 each “bullet point” represents an underlying price update. Again, in FIG. 4 because the underlying price update P₅ found closest to the origin of the graph can be calculated before throttle allows operations and the orders and quotes can be sent, the scheduler initiates a normal calculation. For the next pair of underlying price updates P₆ and P₇, however, even if orders and quotes in reaction to P₆ alone could be calculated before throttle allows operations in the absence of another underlying price update, the presence of the additional underlying price update P₇ has an accumulative effect such that the scheduler will only complete its calculation at or after the moment the throttle allows operations and the orders and quotes can be sent. Thus, as seen in FIG. 4, this accumulative effect based on the existence of two underlying prices results in the extension of the priority horizon of the system backward in time.

Again, in a given exchange activity on a multiplicity of underling prices is occurring. Thus, even the more complete schematic graph of scheduler modes of FIG. 3 is an underrepresentation of the complexity of a spooler in accordance with the principles of the present invention. A spooler in accordance with the principles of the present invention operating in the presence of multiple underling prices must take account of which is the most urgent underlying price and the total work that needs to be done before the throttle allows operations so that it manage the recalculations.

While the invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A computerized trading system comprising an electronic trading spooler, the spooler acting as a master.

2. The computerized trading system of claim 1 further wherein the spooler acts as a master and a calculation engine acts as a slave.

3. The computerized trading system of claim 1 further wherein the spooler allocates computational and communicational resources of the computerized trading system.

4. The computerized trading system of claim 3 further wherein the spooler allocates computational and communicational resources of the computerized trading system based on available throttle towards the exchange on one side and the prediction of orders and/or quotes that will need sending with their computational cost forecast on the other side.

5. The computerized trading system of claim 1 further wherein the trading system determines the desired state of the orders and/or quotes in the market in response to external inputs, the trading system receiving internally from the spooler what to calculate.

6. A computerized trading system comprising a spooler that allocates computational and communicational resources of the computerized trading system, the trading system determining the desired state of the orders and/or quotes in the market in response to external inputs, and the trading system receiving internally from the spooler what to calculate.

7. The computerized trading system of claim 6 further wherein the spooler comprises a scheduler, a package assembly, and a repository, the scheduler provides a signal to the package assembly to trigger the creation of a data package, and the package assembly picks up new orders and/or quote values produced by the calculation engine.

8. The computerized trading system of claim 7 further wherein the package assembly generates a data package of a size up to a maximum stipulated by a particular exchange, and converts the data package into a format dictated by the particular exchange application programming interface.

9. The computerized trading system of claim 7 further wherein the package assembly augments the list of the orders and/or quotes produced by the calculation engine with a pre-existing list of hitherto unsent orders and/or quotes and prioritizes the overall list

10. The computerized trading system of claim 6 further wherein the spooler chooses which calculations are important and the order in which those calculations can be done.

11. The computerized trading system of claim 6 further wherein the spooler allocates computational and communicational resources of the computerized trading system based on available throttle towards the exchange on one side and the prediction of orders and/or quotes that will need sending with their computational cost forecast on the other side.

12. The computerized trading system of claim 6 further wherein the spooler allocates computational and communicational resources of the computerized trading system based on attributes selected from the group comprising available throttle towards exchange, precalculated impact on quoting of possible upcoming market data, costs of computation, and combinations thereof.

13. The computerized trading system of claim 12 further wherein the precalculated impact on quoting of possible upcoming market data comprises a ladder of underlying values with corresponding quoting operations and costs of computation.

14. The computerized trading system of claim 6 further wherein the trading system receives inputs comprising the underlying price and the instrument price.

15. An electronic trading spooler comprising:
a scheduler that determines which of multiple orders and/or quote updates are the most urgent and the total work that needs to be done before a throttle allows operations; and
a package assembly that generates a data package after receiving a signal from the scheduler to trigger the creation of a quoting operation data package of orders and/or quotes.

16. The electronic trading spooler of claim 15 further wherein the package assembly generates the data package of a size up to a maximum stipulated by a particular exchange and converts the data package into a format dictated by the particular exchange application programming interface.

17. The computerized trading system of claim 15 further wherein the scheduler allocates computational and communicational resources.

18. The computerized trading system of claim 17 further wherein the scheduler allocates computational and communicational resources by prioritizing with higher importance determination of orders and/or quotes for the package assembly and by prioritizing to less high importance other work that is not determination of orders and/or quotes for the package assembly.

19. The computerized trading system of claim 18 further wherein determination of orders and/or quotes for the package assembly comprises calculation in preparation of package assembly.

20. The computerized trading system of claim 15 further wherein the scheduler is provided with the profile of the throttle over time.

21. The computerized trading system of claim of 20 further wherein the profile of the throttle is updated with information provided by an exchange

22. The computerized trading system of claim of 21 further wherein the profile of the throttle is updated with information provided by an exchange directly indicating change of state of activity of the throttle.

23. The computerized trading system of claim of 20 further wherein the profile of the throttle is updated by the trading system in the absence of information provided by an exchange.

24. The computerized trading system of claim 15 further wherein the scheduler input comprises predictions of the eligible orders and/or quotes.

25. The computerized trading system of claim 24 further wherein the scheduler input comprises predictions of the eligible orders and/or quotes with use of derivative theoretical prices for different precalculated underlying levels, values of own orders and/or quotes currently published to the market, and trading cost information.

26. A method of scheduling electronic trading based on market data price change comprising:
dividing into non-overlapping regions the upcoming time period and range of expected prices based on outstanding quote states, possible trading costs, and price valuation properties of the quoted products;
maintaining a set of order and/or quotes per region that would need updating were the time and prices fall within the associated region;
if the time and prices fall within a region with an empty set, scheduling non-quote spooling tasks of the trading system;
if the time and prices fall within no region, scheduling a masshold task for execution; and
if the time and prices fall within a region with a non empty set, scheduling the orders and/or quotes of this set that are not up to date for calculation and, when the quoting throttle is inactive, scheduling a quoting data package for assembly with as many of the calculated orders and/or quotes as possible.

27. The method of scheduling electronic trading based on market data price change of claim 26 further including maintaining of regions and sets in dependence to the scheduler profile so as to complete the calculation of the orders and/or quotes at or after the moment throttle allows operations and the orders and/or quotes can be sent.

28. The method of scheduling electronic trading based on market data price change of claim 26 further including scheduling and assembling into packages the orders and/or quotes associated to a non-empty set in accordance to a business criteria of relative or absolute prioritization.

29. The method of scheduling electronic trading based on market data price change of claim 26 further including maintaining regions and sets in dependence of underlying prices of the quoted tradable objects.

30. The method of scheduling electronic trading based on market data price change of claim 26 further including governing the choice of how many order and/or quotes to calculate and assemble where the throttle is inactive by a function provided by the user.
